(19) United States
(12) Patent Application Publication
(10) Pub. No.: US 2002/0150045 A1
(43) Pub. Date: Oct. 17, 2002

(54) Method and device for reliable transmission of data packets

(76) Inventors: Gereon Vogtmeier, Aachen (DE); Francisco Morales Serrano, Aachen (DE); Stefan Schneider, Aachen (DE); Olaf Such, Aachen (DE)

Correspondence Address: U.S. Philips Corporation, 580 White Plains Road, Tarrytown, NY, 10591, US

(21) Appl. No.: 10/050,253

(22) Filed: Jan. 16, 2002

(30) Foreign Application Priority Data
Jan. 19, 2001 (DE) 10102323.5

(51) Int. Cl. H04Q 7/00

(52) U.S. Cl. 370/229

(57) ABSTRACT

The invention relates to a method for loss-free transmission of data packets from a transmitter (10) to a receiver (7). In this arrangement, the transmitting unit (5) of the transmitter continuously transmits data packets to the receiver (7) via the transmission channel (8) and at the same time stores a copy thereof in a buffer (3). The receiver (7) supplies the transmitter (10) with an acknowledge signal (9) concerning the success or failure of the transmission of the data packets. If a data packet has not been successfully transmitted, it is extracted from the buffer (3) by a control unit (4) of the transmitter (10), and inserted once again into the stream of data packets to be transmitted. By contrast, successfully transmitted data packets are erased from the buffer (3). The buffer (3) permits recourse to and the renewed transmission of data packets even when the corresponding acknowledge signal is not awaited after each transmission operation.

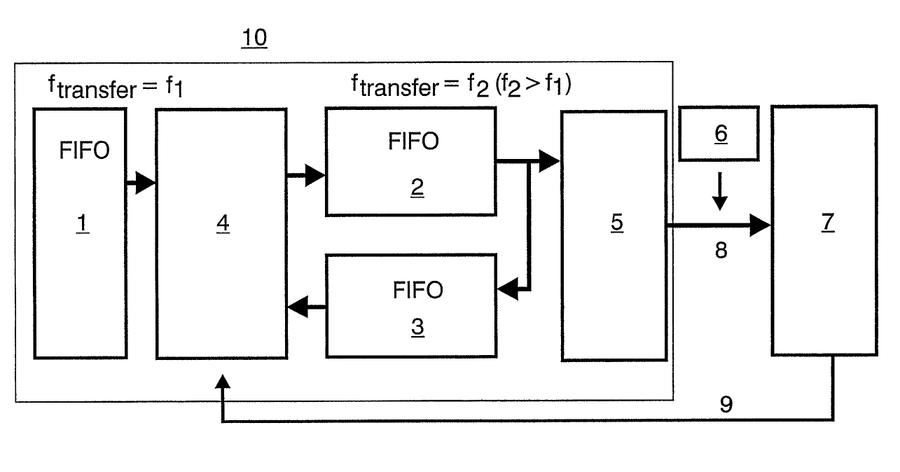

The invention relates to a method for reliable transmission of data packets from a transmitter to a receiver, incorrectly transmitted data packets being retransmitted. The invention also relates to a transmitter suitable for carrying out the method.

In numerous technical applications, it is necessary for data to be transmitted reliably from a transmitter to a receiver, that is to say, without loss of information. An example in this respect is the transmission of raw image data from the detector of an imaging device to an evaluation unit. In the field of medical technology, this is the case, in particular, for the rotating unit (disc) of a computed tomography apparatus as a transmitter and the stator of the tomography apparatus as a receiver. In accordance with the prior art of data transmission of computed tomography apparatus, the data to be transmitted on the disk is first written into a FIFO (first in first out) buffer, and each data packet is subsequently transmitted individually from the disk via a slipring to the receiver (stator). After each data packet, the receiver returns an acknowledge signal to the transmitter on the disk, which signal contains information on whether the data packet has been transmitted successfully and received correctly or not. The transmitter on the disk awaits the reception of the acknowledge signal and transmits the next data packet only when the acknowledge signal indicates the successful transmission of the preceding data packet. If, by contrast, the acknowledge signal indicates incorrect transmission of the data packet, the receiver transmits this data packet a second time. If necessary, the data packet is then sent a number of times by iteration of the method until it has arrived correctly at the receiver.

The described data transmission method ensures that all information of the FIFO memory is transmitted reliably and without loss from the transmitter to the receiver. This is important, in particular, in the case of computed tomography applications in order to keep the exposure of the patient to X-rays as low as possible by fully utilizing the information obtained. However, it is a drawback of the method that the data transmission from the transmitter to the receiver does not utilize the maximum possible transmission rate of the interposed transmission link since, after each transmission of a data packet, the receiver spends “idle time” waiting on an acknowledge signal, during which the transmission path is not used. On the other hand, however, in view of the large volume of data arriving in the case of a computed tomography apparatus, optimum utilization of the transmission capacity would be extremely desirable.

Against this background it was the object of the present invention to provide a device and a method which enable reliable and, at the same time, fast data transmission with optimum utilization of the transmission channel, and are, therefore, suitable, in particular, for transmitting image information in a computed tomography apparatus.

This object is achieved by means of method as disclosed in claim 1 and a transmitter as disclosed in claim 5. Advantageous embodiments are disclosed in the dependent claims.

The method for reliable, that is, loss-free, transmission of data packets from a transmitter to a receiver, therefore, includes the following steps:

a) continuous sending of data packets by the transmitter, a copy of each data packet at the same time being stored in a buffer;

b) transmission of an acknowledge signal from the receiver to the transmitter, the acknowledge signal indicating the success or failure of the transmission of a data packet or of a plurality of data packets; and

c) renewed sending of an incorrectly transmitted data packet by the transmitter, this data packet being extracted from the buffer by the transmitter, and erasure of successfully transmitted data packets from the buffer.

In the method according to the invention, data packets are thus transmitted continuously to the transmission link by the transmitter such that this transmission link is optimally utilized. In particular, after the sending of a first data packet the next data packet is sent directly without awaiting the arrival of an acknowledge signal concerning the first data packet. Idle times in which the transmission channel is not used are thus avoided. However, in order to ensure completely correct transmission of all the data nevertheless, a copy of each transmitted data packet is stored in the buffer before the transmission. The copy can then be called up again as required at a later point in time in order to retransmit the corresponding data packet if the first attempt at transmission should not have been successful. Such a renewed transmission of an unsuccessfully transmitted data packet takes place when the acknowledge signal concerning this data packet from the receiver indicates a failure of the transmission. As already explained, in this case numerous further transmitting operations of other data packets can lie between the second transmission of the data packet and its first transmission.

However, if the acknowledge signal from the receiver indicates that a specific data packet has been successfully transmitted, there is no longer a need for further storage of this data packet in the buffer of the transmitter. After arrival of such an acknowledge signal, the transmitter, therefore, erases the corresponding data packet from the buffer such that the memory location is available again for accepting new data packets.

In accordance with a first version of the method, the transmitter reacts directly (after termination of the current operating cycle) to the arrival of an acknowledge signal. That is to say, the data packets reported as successfully transmitted by the acknowledge signal are erased from the buffer, while the datapackets reported as not successfully transmitted by the acknowledge signal are called up from the buffer and inserted into the stream of data packets to be transmitted. Typically, an acknowledge signal of the transmitter consists of information concerning the success or failure of the transmission of a single data packet, so that the response thereto is to erase the data packet from the buffer or to transmit the data packet again.

In accordance with a further version of the method, whenever the buffer for transmitted data packets is completely occupied, the transmitter stops the continuous transmission of data packets until an acknowledge signal arrives which indicates the successful transmission of a data packet. After arrival of such a transmission signal, the transmitter can, specifically, erase the relevant data packet from the buffer such that storage space becomes free. Subsequently, a new data packet can, therefore, be transmitted and its copy is stored in the buffer. Stopping the transmission when the filling limit of the buffer is reached ensures that a copy of all the data packets sent but not yet confirmed as successfully transmitted is present at the transmitter. A loss of information is, therefore, excluded even when the limit of the buffer is reached. According to a modification of the outlined procedure, when the filling limit of the buffer is reached, it is also possible to transmit data packets only cyclically from the buffer, since this leaves the filling level of the buffer unchanged. Thus, only the continuous transmission of new (“fresh”) data packets is stopped in this case.

In accordance with another version of the method, the transmitter collects incoming acknowledge signals from the receiver and processes these signals at points in time which depend on the filling level of the buffer. If the buffer is occupied with data packets to a comparatively small extent, the transmitter can, therefore, still carry on with the continuous transmission of data packets while storing copies in the buffer. If, by contrast, the filling level of the buffer exceeds an upper limit, or the buffer is even completely filled, the transmitter switches over to processing collected acknowledge signals. In this case, acknowledge signals on successful transmissions of data packets permit the corresponding data packets to be erased from the buffer, such that free storage space is again obtained therein.

The invention also relates to a transmitter for reliable, that is to say loss-free transmission of data packets to a receiver, which transmitter is suitable, in particular, for carrying out the method explained above. The transmitter includes the following elements:

a) an input for the data packets to be transmitted;

b) a transmitting unit for sending data packets to a receiver via a transmission link;

c) a buffer for storing copies of the data packets transmitted via the transmission link;

d) a receiving unit for receiving acknowledge signals from the receiver, the acknowledge signals indicating the success or failure of the transmission of data packets; and

e) a control unit which controls the relaying of data packets from the input and from the buffer to the transmitting unit and in the process feeds data packets not transmitted successfully to the transmitting unit once again, and erases successfully transmitted data packets from the buffer.

The transmitter can be used in conjunction with an appropriately set up receiver which sends back to the transmitter acknowledge signals on the success or failure of a data packet transmission. In accordance with the above-explained method, it is possible in this case for data packets to be sent continuously to the transmission link without first having to await the input of the associated acknowledge signal after each data packet. The loss of information is avoided by virtue of the fact that copies of all data packets transmitted and not yet acknowledged as having successfully arrived are stored in the buffer. The control unit can access this buffer in order, if required, to feed a data packet not successfully transmitted once again to the transmitting unit for a second or, in general, nth attempt at transmission. Data packets which are acknowledged as having been successfully transmitted are, by contrast, permanently erased from the buffer by the control unit, in order to create space there in for further copies of transmitted data packets.

The input of the transmitter preferably has a buffer for data packets to be transmitted. The buffer may notably be a FIFO memory. This buffer permits matching of different data transmission rates of the actual data source, for example, the imaging unit of a computed tomography apparatus, and of the transmitter itself. Typically, these transmission rates are unequal, or the transmissions are asynchronous, such that the buffer serves to buffer incoming data packets. Such a buffer is generally also present in known transmitters. It has to be designed to be very large therein, so that no incoming data is lost during the waiting time for an acknowledge signal and, in particular, in the case of multiple unsuccessfully attempts at transmission during which no data packets flow out of the FIFO. Such a blocking situation cannot occur in the case of the transmitter according to the invention, since it transmits data packets continuously. Consequently, the buffer of the input can be of correspondingly smaller dimensions.

In accordance with further embodiment of the transmitter, a buffer for data packets to be transmitted is arranged in the data transmission path upstream of the transmitting unit. This buffer can also be a FIFO memory and serves notably for the matching of different transmission rates.

Preferably, the transmitter is arranged in the rotating image acquisition unit (disc) of a computed tomography apparatus and the receiver is arranged in the associated fixed stator of the computed tomography apparatus. As has already been explained above, precisely in the case of the transmission link between a disk and a stator a situation arises in which large data volumes must be transmitted quickly and as completely free of errors as possible via transmission link which is very prone to errors. The advantages of the transmitter, therefore, become manifest in particular in this case.

The invention is explained below, by way of example, with the aid of the FIGURE. The sole FIGURE shows a block diagram of the components of a transmitter according to the invention which transmit data to a receiver via an error-prone transmission link.

The transmitter 10 illustrated in the FIGURE can be arranged, in particular, in the rotating unit (disc) of a computed tomography apparatus, while the associated receiver 7 is formed by the evaluation unit of the stator. The transmission path 8 for data from the transmitter 10 to the receiver 7 passes via the slipring between the disc and the stator. For technical reasons, this transmission path is comparatively error-prone as indicated in the FIGURE by the error source 6.

The high data rates at which the data of high-resolution detectors must be transported to the evaluation unit cause a problem in particular whenever, as in the case of medical computed tomography applications, no loss and no falsification of the data packets during transmission are acceptable. In the case of conventional transmission concepts, the incoming data is first buffered in a FIFO memory 1 at the input, and then led, via a further FIFO memory 2, to the transmitting unit 5, from where it is sent to the transmission path 8. Conventional transmitters then postpone the next transmission of a data packet until the acknowledge signal 9 has been transmitted back by the receiver 7. If this acknowledge signal indicates the successful transmission of the data packet, the next data packet is extracted from the FIFO 1 and sent by the transmitting unit 5. If, by contrast, the previous data packet has not been correctly transmitted, in the case of conventional concepts its copy is extracted once again from the FIFO memory 2 so as to be retransmitted. During the waiting time for the confirmation signal, no transmission, therefore, takes place in the transmission path 8 so that latter is frequently not in use. The loss of transmission capacity is high, in particular, whenever the response times of the receiver 7 are comparatively long. A problem also occurs when a specific data packet cannot be successfully transmitted a number of times in succession, and the subsequent data packets, therefore pile up in the FIFO 1. In the worst case, a data loss can then occur due to overflow of the FIFO 1.

In order to make better use of the capacity of the transmission path 8, the transmitter according to the invention is equipped with a FIFO buffer 3 and with a control unit 4 set up in a specific way. Each data packet sent by the transmitting unit 5 is in this case stored in the form of a copy in the buffer 3 before being transmitted. Directly after the data packet has been sent, the next data packet present in the buffer 2 is extracted therefrom, a copy thereof is stored in the buffer 3, and the data packet is sent by the transmitting unit 5. Consequently, the arrival of an acknowledge signal 9 for the first data packet is not awaited but continuous data transfer to the receiver 7 takes place. The transmission link 8 is, therefore, utilized as well as possible.

When an acknowledge signal 9, coming from the receiver 7, to the transmitter 10 indicates that a data packet has been transmitted incorrectly, incompletely or not at all, the control unit 4 extracts this data packet from the buffer 3 and leads it once again to the buffer FIFO 2, so that it can be sent a second time by the transmitter 5. The data packet can be erased in the buffer 3 during the extraction since, in accordance with the usual routine, it is stored again as a copy in the buffer 3 during a next attempt at transmission. In the case of a transfer error, the defectively transmitted data packet is therefore fed again from the buffer 3 into the continuous data stream.

Data packets for which the associated acknowledge signal 9 indicates that they have been correctly transmitted can be erased permanently from the buffer 3. Space for storing new copies of data packets is thus continuously recreated in the buffer.

The transmission capacity of the transmission link 8 should be designed to be somewhat greater than value corresponding to the data rate f₁ at the input 1. The reason for this is that the transmission link 8 is subject to a somewhat larger load f₂>f₁due to the repeated transmission of incorrect data packets. The level of this additionally required capacity of the transmission path 8 is directly related to its susceptibility, since the latter, in turn, determines the frequency at which data packets are to be repeatedly transmitted.

In comparison with conventional transmitters, it is possible to reduce the size of the buffer, since now it depends only on the data rate and the response time for the acknowledge signals 9, but is substantially independent of the error rate on the transmission link 8.

A series of advantages can, therefore, be realized by means of the transmitter/receiver pair illustrated in the FIGURE:

the data rate on the transmission link 8 is independent of the response time for the acknowledge signals 9;

a higher effective data throughput can be achieved;

no data traffic jam is produced in the case of multiple transmission errors;

a lower overall storage requirement for buffers (can be dimensioned on the basis of response time and maximum transfer rate);

higher data transfer rate for the same transmission reliability; cost saving owing to smaller, defined buffer.

Whereas the example of a transmission of imaging data in computed tomography has been placed in the foreground, the application of the concept according to the invention is not limited thereto. Feasible fields of application are all cases involving high data transfer rates and a 100% transmission reliability (by acknowledge) in conjunction with a transmission time that is limited or to be minimized (for example, high-speed downloading with acknowledge data uploading at lower speed).

1. A method for reliable transmission of data packets from a transmitter (10) to a receiver (7), preferably for transmitting data packets from the rotating image acquisition unit of a computed tomography apparatus to the fixed stator, in which:
a) the transmitter continuously sends data packets and at the same time stores a copy thereof in a buffer (3);
b) the receiver informs the transmitter of success or failure of the transmission of data packets with the aid of an acknowledge signal (9); and
c) the transmitter again sends a defectively transmitted data packet from the buffer (3), whereas it erases successfully transmitted data packets from the buffer.

2. A method as claimed in claim 1, wherein, immediately after receiving an acknowledge signal (9), the transmitter (10) again sends the data packets affected thereby, or erases them.

3. A method as claimed in claim 1 or 2, wherein, if the buffer (3) is full, the transmitter (10) stops the continuous transmission of data packets until the arrival of acknowledge signals (9) concerning successfully transmitted data packets.

4. A method as claimed in at least one of claims 1 to 3, wherein the transmitter (10) collects acknowledge signals (9) and processes them as a function of the filling level of the buffer (3).

5. A transmitter (10) for reliable transmission of data packets to a receiver (7), including
a) an input (1) for data packets to be transmitted,
b) a transmitting unit (5) for sending data packets via a transmission link (8),
c) a buffer (3) for storing copies of the transmitted data packets,
d) a receiving unit (4) for receiving acknowledge signals (9) from the receiver which signal the success or failure of the transmission of data packets, and
e) a control unit (4) which controls the relaying of data packets from the input (1) and from the buffer (3) to the transmitting unit (5), feeds data packets not transmitted successfully to the transmitting unit once again, and erases successfully transmitted data packets from the buffer.

6. A transmitter as claimed in claim 5, wherein the input has a buffer (1) for data packets to be transmitted.

7. A transmitter as claimed in claim 5 or 6, wherein a buffer (2) for data packets to be transmitted is arranged upstream of the transmitting unit (5).

8. A transmitter as claimed in at least one of claims 5 to 7, wherein the transmitter (10) is arranged in the rotating image acquisition unit of a computed tomography apparatus and the receiver (7) is arranged in the associated fixed stator.

9. A computed tomography apparatus which includes a transmitter (10) and a receiver (7)
the transmitter being arranged to send data packets continuously and to store at the same time a copy thereof in a buffer (3),
the receiver being arranged to inform the transmitter of success or failure of the transmission of data packets with the aid of an acknowledge signal (9), and
the transmitter being arranged to send a defectively transmitted data packet from the buffer (3), whereas it erases successfully transmitted data packets from the buffer.

10. A computed tomography apparatus which includes a transmitter (10) and a receiver (7), which transmitter includes:
a) an input (1) for data packets to be transmitted,
b) a transmitting unit (5) for sending data packets via a transmission link (8),
c) a buffer (3) for storing copies of the transmitted data packets,
d) a receiving unit (4) for receiving acknowledge signals (9) from the receiver which signal the success or failure of the transmission of data packets, and
e) a control unit (4) which controls the relaying of data packets from the input (1) and from the buffer (3) to the transmitting unit (5), feeds data packets not transmitted successfully to the transmitting unit once again, and erases successfully transmitted data packets from the buffer.
